(19) United States
(12) Patent Application Publication
(10) Pub. No.: US 2010/0281476 A1
(43) Pub. Date: Nov. 4, 2010

(54) Image forming apparatus and image forming system

(75) Inventor: Yukari Ebi, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/798,620

(22) Filed: Apr. 8, 2010

(30) Foreign Application Priority Data
Apr. 30, 2009 (JP) 2009-110493

(51) Int. Cl. G06F 9/445

(52) U.S. Cl. 717/174

(57) ABSTRACT

Provided is an image forming apparatus which makes input of an initial setting value of driver software such as a printer driver easier and capable of preventing erroneous input. A MFP is connected through a network to an administrator PC in which driver software is installed, and controlled by the driver software. The MFP includes an initial setting value input portion for inputting an initial setting value of the driver software and a setting value table that stores a setting value of an image forming function included in the MFP. The initial setting value input portion sets the setting value stored in the setting value table on an initial setting value input screen of the driver software as the initial setting value of the driver software so that a user can change the initial setting value set on the initial setting value input screen.

### CROSS-NOTING PARAGRAPH

This Non-provisional application claims priority under 35 U.S.C. §119 (a) on Patent Application No. 2009-110493 filed in JAPAN on Apr. 30, 2009, the entire contents of which are hereby incorporated herein by reference.

### FIELD OF THE INVENTION

The present invention relates to an image forming apparatus and an image forming system, and more particularly to an image forming apparatus and an image forming system capable of inputting an initial setting value of driver software such as a printer driver.

### BACKGROUND OF THE INVENTION

In recent years, activities to reduce Co₂ emissions have been widespread, and although distribution by an electronic file using an electronic mail etc., or an electronic filing for reducing the amount of printing is on the increase, it is difficult to realize the printing on recording paper to be zero in a corporation or the like. Therefore, in a corporation or the like, an effort to reduce recording paper, toners, power consumption in printing is made by performing a so-called eco printing that reduces the sheet number of recording paper to be printed. Specifically, for example, by switching the color printing, the 1-sided printing and 1 in 1 (1-up) that prints one page on one sheet of the recording paper respectively to the black and white printing, the 2-sided printing, and N in 1 (N-up: N is 2 or more) that intensively prints a plurality of pages on one sheet of the recording paper, the eco printing as described above can be performed.

For example, in a case where a copy is performed by a MFP (digital multi-functional peripheral) including a printer function and a copy function, when a system administrator or the like sets a copying condition taking account of the environment in advance such as the N in 1 copy or the 2-sided copy as an initial setting value, it is possible to execute copying on the copying condition of the initial setting value unless a user changes the copying condition intentionally whenever he copies. Therefore, the eco printing can be performed relatively easily.

However, there has been a problem that the changing processing is troublesome because the printing condition of the printer driver of each of the plurality of PCs should be changed when a plurality of PCs are connected to the MFP through a network, although a printing condition of a printer driver installed in the PC requires that setting thereof is changed for the condition of the eco printing when printing data is transmitted to a MFP from a PC (Personal Computer) or the like that a user uses and printing is performed by the MFP.

Moreover, since installing of a printer driver in a PC is performed by a user at any time, it is difficult even for an administrator of a MFP to grasp all the PCs in which the printer driver is installed, and to change the printing condition of the printer driver of all the PCs.

On the contrary, for example, Japanese Laid-Open Patent Publication No. 2005-332100 describes a print setting sharing support apparatus that is capable of incorporating an initial setting value of a printer driver in which printing conditions are set in advance by an administrator or the like into a printer driver by downloading with a web function, and is capable of sharing the printing condition of the printer driver between the plurality of the PCs.

In the case of the technology that the above-described Japanese Laid-Open Patent Publication No. 2005-332100 describes, there has been a problem that it takes a trouble with the input setting of the initial setting value or an inappropriate initial setting value is erroneously input, since an unaccustomed user or the like does not know the printing condition to be input as the initial setting value, although input of the initial setting value of the printer driver is performed for the print setting sharing support apparatus from an own PC of a user such as a system administrator.

For these problems, since setting values such as the number of printing copies, a printing direction, a paper tray, a paper discharge tray, a paper type, the 2-sided printing and the like are stored in advance in an image forming apparatus such as a MFP connected to a PC, it is considered that the input setting processing of the initial setting value is made to be easier by using these setting values as the initial setting value of the printer driver. For example, when a setting value for the above-described eco printing is stored in the image forming apparatus, it is possible to use the setting value as it is as the initial setting value of the printer driver.

However, in the conventional technique, since there is no way of thinking that the initial setting value of the printer driver is input and set from the image forming apparatus and further, there is no way of thinking that the setting value of the image forming apparatus is used as the initial setting value of the printer driver, the input setting processing of the initial setting value of the printer driver is a great burden for the system administrator or the like.

### SUMMARY OF THE INVENTION

An object of the present invention is, to make the input of an initial setting value of driver software such as a printer driver easier, and to provide an image forming apparatus and an image forming system capable of suppressing erroneous input.

Another object of the present invention is to provide an image forming apparatus that is connectable through a network to an information processing apparatus in which driver software is installed, and is controlled by the driver software, wherein an initial setting value input portion for inputting an initial setting value of the driver software is included and the initial setting value input by the initial setting value input portion is transmitted in response to a request from an external apparatus.

Another object of the present invention is to provide the image forming apparatus, wherein a setting value table that stores a setting value of an image forming function included in the image forming apparatus is provided, the initial setting value input portion sets the setting value stored in the setting value table on an initial setting value input screen of the driver software as an initial setting value of the driver software so that a user can change the initial setting value set on the initial setting value input screen.

Another object of the present invention is to provide the image forming apparatus, wherein the image forming apparatus includes any one or more of a printer function, a scanner function, and a facsimile function as the image forming function.

Another object of the present invention is to provide the image forming apparatus, wherein it is possible to display a preview image based on an initial setting value before or after changed by a user on the initial setting value input screen.

Another object of the present invention is to provide the image forming apparatus, wherein it is possible to execute a test printing based on an initial setting value before or after changed by a user on the initial setting value input screen.

Another object of the present invention is to provide the image forming apparatus, wherein when the image forming apparatus is provided with a plurality of image forming functions including a printer function, the setting value table includes a sharing setting value table that shares and stores at least a part of a setting value of the printer function and at least a part of a setting value of other image forming function except the printer function.

Another object of the present invention is to provide the image forming apparatus, wherein when the image forming apparatus is provided with a plurality of image forming functions including a printer function, the setting value table includes a first setting value table that stores a setting value of the printer function and a second setting value table that stores a setting value of other image forming function except the printer function.

Another object of the present invention is to provide the image forming apparatus, wherein the other image forming function is a copy function.

Another object of the present invention is to provide the image forming apparatus, wherein a storage portion that stores an initial setting value of the driver software input by the initial setting value input portion is included.

Another object of the present invention is to provide an image forming system that an information processing apparatus in which driver software is installed and an image forming apparatus controlled by the driver software are connected through a network, wherein the image forming apparatus includes an initial setting value input portion for inputting an initial setting value of the driver software and transmits the initial setting value input by the initial setting value input portion in response to a request from an external apparatus.

### BRIEF DESCRIPTION OF THE DRAWINGS

FIG. 1 is a diagram showing a configuration example of an image forming system according to an embodiment of the present invention;

FIG. 2 is a block diagram showing a configuration example of an administrator PC and a MFP shown in FIG. 1;

FIGS. 3A to 3C are diagrams showing an example of a setting value table included in the MFP;

FIGS. 4A to 4B are diagrams showing another example of the setting value table included in the MFP;

FIG. 5 is a diagram showing an example of an input screen of an initial setting value displayed on a display portion of the MFP;

FIG. 6 is a flow diagram explaining an example of a method of inputting the initial setting value by the MFP of the present invention;

FIG. 7 is a flow diagram explaining an example of renewal processing of the initial setting value on the administrator PC; and

FIG. 8 is a diagram showing an example of a changing screen of the initial setting value displayed on the administrator PC.

### PREFERRED EMBODIMENTS OF THE INVENTION

Hereinafter, description will be given for a preferred embodiment according to an image forming apparatus and an image forming system of the present invention with reference to the attached drawings.

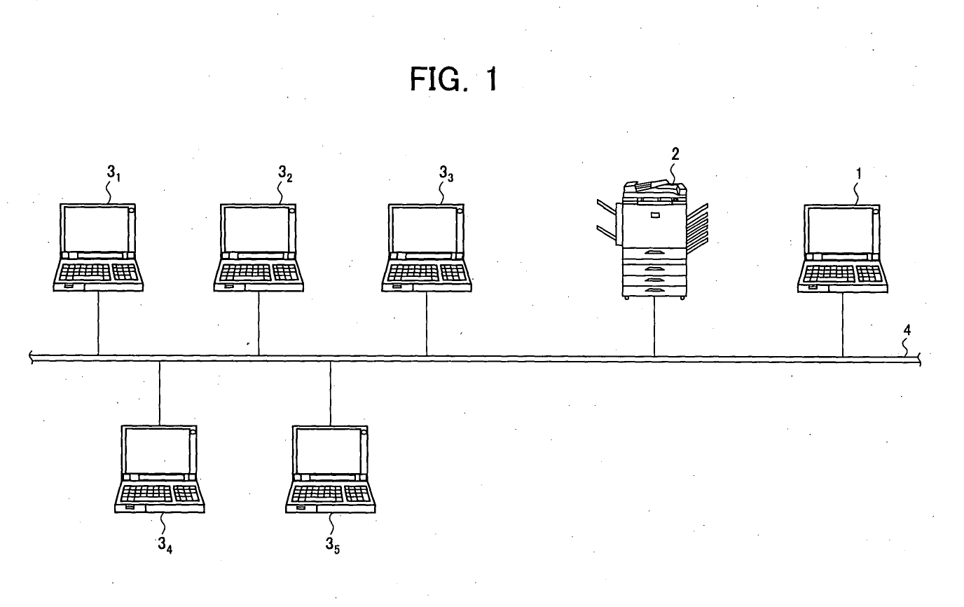

FIG. 1 is a diagram showing a configuration example of an image forming system according to an embodiment of the present invention, and in the diagram, 1 denotes an administrator PC (Personal Computer) which is an example of an information processing apparatus, 2 denotes a digital multi-functional peripheral (hereinafter, referred to as MFP) as an example of the image forming apparatus, 3₁ to 3₅ denote client PCs, and 4 denotes a network such as a LAN (Local Area Network). The administrator PC 1, MFP 2, and the client PCs 3₁ to 3₅ (hereinafter, also referred to as client PC 3) are interconnected through the network 4, and the MFP 2 executes image forming processing such as printing, based on an instruction from the administrator PC 1 or the client PC 3.

The administrator PC 1 and the client PC 3 are composed of general-purpose computers, and driver softwares such as a printer driver, a scanner driver, and a FAX driver required for performing an image forming in the MFP 2 are installed in advance. An initial setting value which is the default is set in these driver softwares, and when an image forming is performed from the administrator PC 1 or the client PC 3, the user is able to perform the image forming processing by using the initial setting value of the driver software as it is, or by changing the initial setting value corresponding to a condition of the image forming.

It is assumed that the setting values according to a plurality of image forming functions such as a copy function, a printer function, a scanner function and a facsimile function are stored in advance. For example, as items of the setting values of the printer function, the number of printing copies, the printing direction, the paper tray, the paper discharge tray, the paper type, and the 2-sided printing are included. Also for other image forming functions except the printer function, a setting value for each item corresponding to the function is stored in advance.

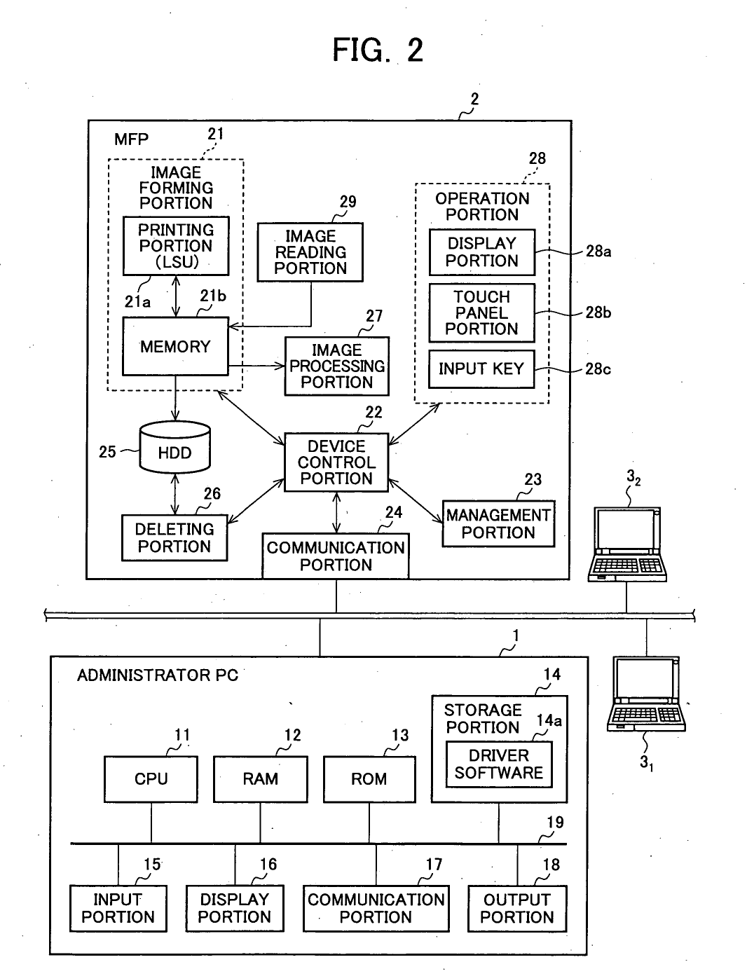

FIG. 2 is a block diagram showing a configuration example of an administrator PC and a MFP shown in FIG. 1. Although the configuration of the administrator PC 1 is described here as a representative example, other client PC 3 is also basically configured similarly. Additionally, although the MFP 2 is illustrated and described as the image forming apparatus, it is not limited to this example and may be a single-functional printer apparatus, a scanner apparatus, a facsimile apparatus, or the like which can be controlled by driver software installed in the PC.

The MFP 2 of the present example is configured as a multi-functional peripheral including a plurality of functions such as a printer function, a copy function, a facsimile function, a scanner function and the like. The MFP 2 includes an image forming portion 21 that performs printing processing of data, a device control portion 22 that controls each function included in the MFP 2, a management portion 23 that is a memory for storing control information, setting information or the like of the MFP 2, a communication portion 24 that communicates with the administrator PC 1 or the client PC 3 through the network 4, an HDD (Hard Disk Drive) 25 that is an example of a storage portion for storing various data, a deleting portion 26 that deletes data stored in the HDD 25, an image processing portion 27 for performing various image forming processing for data, an operation portion 28 that receives operation input by a user, and an image reading portion 29 that electrically reads an image of an original.

Additionally, the image forming portion 21 includes a printing portion 21a such as a LSU (Laser Scanning Unit) and a volatile memory 21b that temporarily retains the data subjected to image processing in the image processing portion 27.

Furthermore, the operation portion 28 includes a display portion 28a such as a LCD (Liquid Crystal Display), a touch panel portion 28b that receives operation input from a user through a touch panel, and an input key 28c that is composed of a group of input keys such as various operation keys and a numeric keypad, and a user is able to perform the input of an operation or the input of the various settings for the MFP 2.

Hereinafter, description will be given simply for the operation example relating to the image processing mode equipped in the MFP 2.

### (Copy Mode)

When the MFP 2 is used as a copier, the data of the original read by the image reading portion 29 is output as a copied matter by the image forming portion 21.

The image reading portion 29 including a not-shown CCD (Charge Coupled Device) is able to read an image of an original set at a reading position electronically. Then the data of the read original is completed as output data on the volatile memory 21b and stored in the HDD 25 temporarily. When there is a plurality of originals, the operation of reading and storing is repeated. After that, the data stored in the HDD 25 is read at an appropriate timing sequentially and sent to the volatile memory 21b based on a processing mode instructed by the operation portion 28. Then, the data is transferred from the volatile memory 21b to the printing portion 21a corresponding to the timing of writing to the printing portion 21a.

### (Printer Mode)

Next, when the MFP 2 is used as a printer, the data received by the communication portion 24 is output from the image forming portion 21 through the volatile memory 21b or the like. Note that, a printer driver is installed in the administrator PC 1 or the client PC 3, and each PC is able to control the printer function of the MFP 2.

The communication portion 24 is connected to the network 4 by wire or radio, and receives data from the administrator PC 1 or the client PC 3 connected to the network 4. The data received in this manner is sent to the volatile memory 21b as the data to be output page by page and stored in the HDD 25 temporarily as required. Then the data is sent again from the HDD 25 to the volatile memory 21b and transferred to the printing portion 21a in a similar manner to the case of using as the copier described above.

### (Scanner Mode)

Furthermore, when the MFP 2 is used as a network scanner, the data of the original read in the image reading portion 29 can be transmitted from the communication portion 24 to the administrator PC 1 or the client PC 3 through the network 4. Here, the original is also read by a CCD included in the image reading portion 29 electronically. Then, the data of the read original is completed as output data on the volatile memory 21b and stored in the HDD 25 temporarily. This data is then sent from the HDD 25 to the volatile memory 21b again and transmitted to a target transmitting destination from the communication portion 24 using an electronic mail or the like after the communication with the transmitting destination indicated through the operation portion 28 is build up. Note that, each PC is able to control the scanner function of the MFP 2 by installing a scanner driver in the administrator PC 1 or the client PC 3.

### (Facsimile Mode)

When the MFP 2 is used as a facsimile apparatus, the communication portion 24 is able to connect with the facsimile apparatus through the network 4. Furthermore, when the communication portion 24 includes a modem function, connection with the facsimile apparatus through a telephone line is possible. Note that, each PC is able to control the facsimile function of the MFP 2 by installing a FAX driver in the administrator PC 1 or the client PC 3.

Each configuration part of the MFP 2 according to the present embodiment is controlled by the device control portion 22, monitors operation instructions from an input key 28c such as the group of input keys provided in the operation portion 28, and exactly guides and displays information to be given to the user such as information concerning a state of the MFP 2 through the display portion 28a. Additionally, the management portion 23 manages the information concerning each configuration portion controlled by the device controlling portion 22, and the device control portion 22 controls the operation of the entire MFP 2 based on the information.

In FIG. 2, the administrator PC 1 is composed of a general-purposed computer, for example, and composed of a CPU 11 that controls an operation of the client PC 1, a RAM 12 that is an execution region of a control program or the like, a ROM 13 that stores a control program, data and the like, a storage portion 14 that is composed of an HDD or the like, an input portion 15 that is composed of a pointing device such as a mouse or a keyboard, a display portion 16 such as a LCD, a communication portion 17 that is a communication interface for connecting with the network 4, an output portion 18 that outputs data to an external device such as a printer, and a system bus 19 that interconnects each portion thereof. Driver software 14a which is required to execute the image forming processing in the MFP 2 is stored in the storage portion 14, for example, and the CPU 11 reads it out to the RAM 12 so as to be executed.

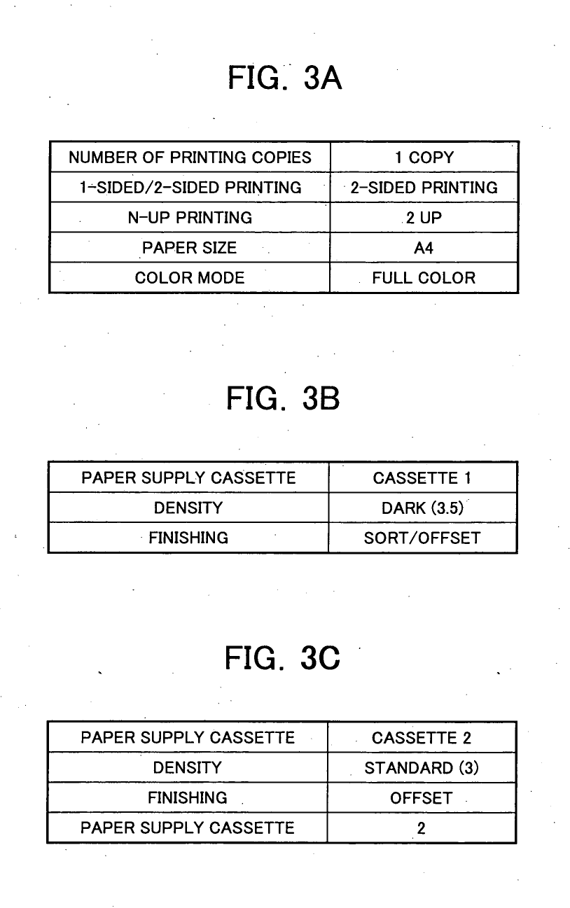

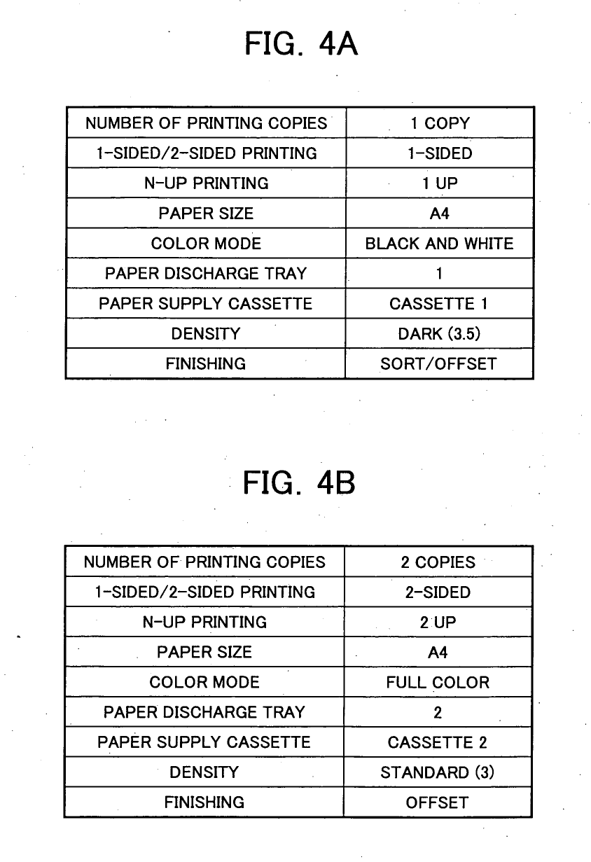

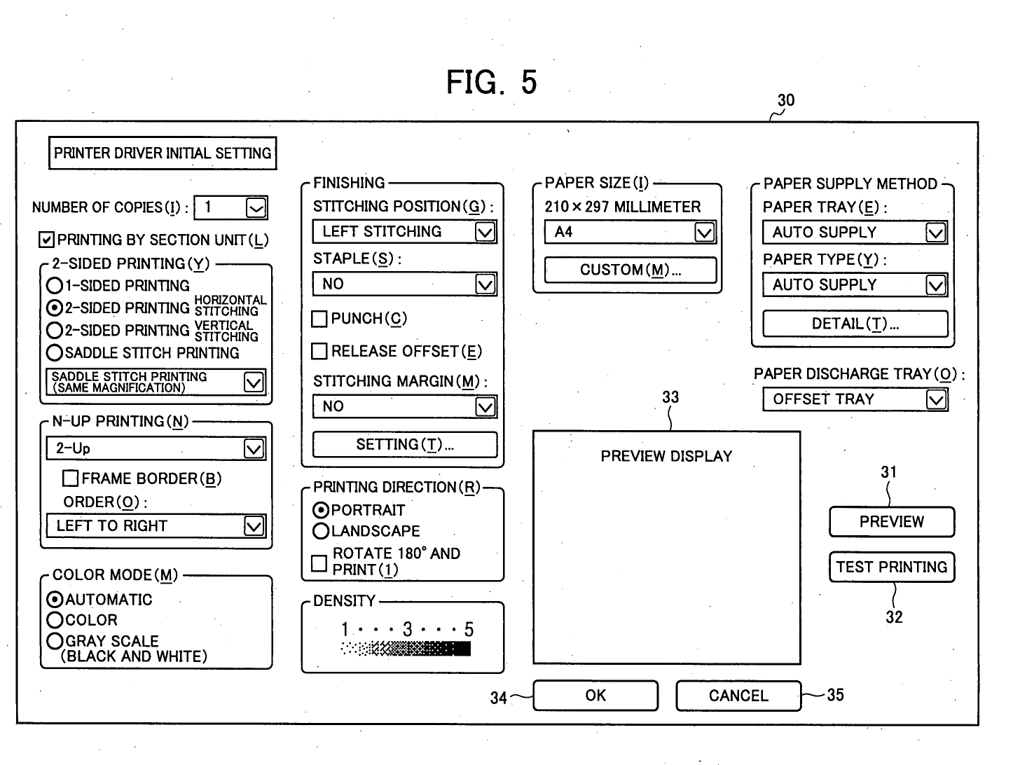

The main characteristic part of the present invention is to easily input the initial setting value of the driver software such as a printer driver and to prevent erroneous input. As a configuration for this, the MFP 2 includes an initial setting value input portion for inputting an initial setting value of the driver software 14a of the MFP 2 installed in the administrator PC 1, and transmits the initial setting value input from the initial setting value input portion corresponding to a request from the outside. The initial setting value input portion is realized by the device control portion 22 and the operation portion 28. For example, the MFP 2 includes a setting value table (FIGS. 3A to 4B described below) in which a setting value of an image forming function included in the MFP 2 is stored. The initial value setting input portion sets a setting value stored in the setting value table to an initial setting value input screen (FIG. 5 described below) of the driver software 14a as an initial setting value of the driver software 14a. Then, the initial setting value set onto the initial setting value input screen can be changed by a user at any time. The user is able to change the initial setting value from a touch panel portion 28b or an input key 28c of the operation portion 28.

In the above, for example, in the case of the printer function of the MFP 2, since each setting value such as the number of printing copies, the 1-sided/2-sided printing, the N-up printing, the paper size, the color mode, the paper discharge tray, the paper supply cassette, the density, the finishing and the like is stored, each of these setting values is used as the initial setting value of the printer driver. Then, it is possible to input the initial setting value of the printer driver easily and to prevent erroneous input when a user such as the administrator changes the initial setting value as required. For example, it is possible to apply the setting value as it is to the initial setting value of the printer driver, when the setting value for the eco printing described above is stored in the MFP 2.

FIGS. 3A to 3C are the diagrams showing an example of the setting value table included in the MFP 2. FIG. 3A shows a sharing setting value table, FIG. 3B shows a copy setting value table, and FIG. 3C shows a printer setting value table. Such setting value tables are stored in the storage portion 14, for example, and configured so that the device control portion 22 can refer to. Then in the setting value table, as described above, the setting value according to the image forming function of the MFP 2 is stored. The setting value table of the present example includes the sharing setting value table (FIG. 3A) that shares and stores at least a part of the setting value of the printer function and at least a part of the setting value of the copy function as an example of another image forming function. Note that, as another image forming function, for example, a setting value of the scanner function or the facsimile function may be shared with the setting value of the printer function.

The number of printing copies, the 1-sided/2-sided printing, the N-up printing, the paper size, the color mode, and the like are included in items to be shared in the sharing setting value table illustrated in FIG. 3A, and the setting value of each item is shared between the printer function and the copy function. Moreover, the paper supply cassette, the density, the finishing and the like are included in items of the copy setting value table shown in FIG. 3B, and the setting value of each item is set independently for the copy function. Furthermore, the density, the finishing and the paper discharge tray and the like are included in items of the printer setting value table, the paper supply cassette, and the setting value of each item is set independently for the printer function.

As the above-described example, for the copy function and the printer function, contents to be set are often similar such as the color mode, the N-up, and the 1-sided/2-sided printing, and therefore, it is possible to reduce the storage capacity required to store the setting value table by sharing these setting values by one table.

FIG. 4A and FIG. 4B are the diagrams showing another example of the setting value table included in the MFP 2. FIG. 4A shows a copy setting value table and FIG. 4B shows a printer setting value table. These setting value tables are stored in the storage portion 14, for example, and configured so that the device control portion 22 can refer to. The setting value table of the present example is composed of the printer setting value table (FIG. 4B) that corresponds to a first setting value table which stores the setting value of the printer function, and the copy setting value table (FIG. 4A) that corresponds to a second setting value table which stores the setting value of the copy function as an example of another image forming function. Note that, as another image forming function, a scanner setting value table that stores the setting value of the scanner function or a facsimile setting value table that stores the setting value of the facsimile function may be included, for example.

The number of printing copies, the 1-sided/2-sided printing, the N-up printing, the paper size, the color mode, the paper discharge tray, the paper supply cassette, the density, the finishing and the like are included in items of the copy setting value table shown in FIG. 4A, and the setting value of each item is set independently for the copy function. Moreover, the number of printing copies, the 1-sided/2-sided printing, the N-up printing, the paper size, the color mode, the paper discharge tray, the paper supply cassette, the density, the finishing and the like are included in items of the printer setting value table show in FIG. 4B, and the setting value of each item is set independently for the printer function.

Although the sharing setting value table is shown in the above-described examples of FIG. 3A to FIG. 3C, there is a case where the paper discharge tray is made different so as to prevent mixing with other jobs or a case where the paper supply cassette is changed so as to change the recording paper to be used, for example. In such a case, by including the setting value table independently as shown in FIG. 4A and FIG. 4B, it is possible to manage the setting value for each function easily. Furthermore, in the case of the copy function and the printer function, it is possible to limit the operation depending on the function such as forbidding the use of special paper inserted into the paper supply cassette.

FIG. 5 is a diagram showing an example of an initial setting value input screen displayed on the display portion 28a of the MFP 2, and in the diagram, 30 denotes the initial setting value input screen, 31 denotes a preview button, 32 denotes a test printing button, 33 denotes a preview display region, 34 denotes an OK button, and 35 denotes a cancel button. As described above, the MFP 2 is operated by the user such as the administrator, and when “initial setting value input” is instructed to select from the menu or the like, the setting value stored in the setting value table shown in the FIG. 3A to FIG. 3C or in the FIG. 4A and FIG. 4B is displayed on the display portion 28a in a state of being set on the initial setting value input screen 30 of the driver software 14a, as the initial setting value of the driver software 14. Here, the setting value stored in the sharing setting value table and the printer setting value table is set/displayed on the initial setting value input screen 30 in the case of examples of FIG. 3A to FIG. 3C since the driver software 14a is the printer driver (hereinafter, also referred to as printer driver 14a). Moreover, in the case of examples of FIG. 4A and FIG. 4B, the setting value stored in the printer setting value table is set/displayed on the initial setting value input screen 30.

The administrator depresses the OK button 34 when the initial setting value set on the initial setting value input screen 30 is not necessary to be changed, and stores the initial setting value in the HDD 25 of the MFP 2 as the initial setting value of the printer driver. Additionally, when this is not the case, the cancel button 35 is depressed and the initial setting value input processing is stopped. When the initial setting value set on the initial setting value input screen 30 is desired to be changed, the administrator operates the touch panel portion 28b or the input key 28c of the operation portion 28 to change the value to a desired initial setting value, and thereafter depresses the OK button 34. In this case, the initial setting value after changing is stored in the HDD 25.

In this manner, the administrator operates the MFP 2 so that the initial setting value input screen 30 is displayed on the touch panel portion 28b, adjusts the initial setting value of the driver software 14a appropriately on the initial setting value input screen 30 and thereafter is able to cause the MFP 2 to store the initial setting value.

Here, in executing printing by the printer function or in reading an image by the scanner function, accessing the MFP 2 is performed from the administrator PC 1 or the client PC 3 through the driver software 14a. Therefore, by storing the initial setting value inside the MFP 2 as described above, there is no need to access an external device such as a server device, and it is possible to perform renewal determination of the initial setting value of the driver software 14a easily. For example, when the driver software 14a accesses the MFP 2, by comparing the initial setting value set in the driver software 14a and the initial setting value stored in the MFP 2 for each item, it is possible to determine whether or not renewal is performed. Then, when it is determined that renewal is performed, the initial setting value set in the driver software 14a is replaced with the initial setting value stored in the MFP 2 with respect to the renewed item.

Furthermore, the MFP 2 is also able to transmit the initial setting value stored in the MFP 2 to the administrator PC 1 according to operation or the like by the administrator when renewal of the initial setting value is performed. In the administrator PC 1, the initial setting value received from the MFP 2 can be set as the initial setting value of the driver software 14a based on the operation of the administrator. Then, the administrator may operate the administrator PC 1 to transmit the initial setting value of the driver software 14a set as described above to other client PC 3 so as to be set by each client PC 3.

In this manner, when inputting the initial setting value from the MFP 2 to the driver software 14a, since the initial setting value input screen 30 can be displayed in a state where the setting value of the MFP 2 has been set, even when the user such as the administrator is unaccustomed, the user is able to input the initial setting value with no hesitation and it is possible to prevent the erroneous input of the initial setting value by using the setting value of the MFP 2.

In FIG. 5, when the preview button 31 on the initial setting value input screen 30 is depressed, a preview image based on an initial setting value before or after changed by a user can be displayed on the preview display region 33. Furthermore, when the test printing button 32 on the initial setting value input screen 30 is depressed, a test printing based on the initial setting value before or after changed by a user can be executed. In such cases, the MFP 2 is assumed to include the preview function and the test printing function.

When inputting the initial setting value of the printer driver 14a from the PC such as the administrator PC 1, it is difficult to image the real printed matter by the input initial setting value, however, when inputting of the initial setting value of the driver software 14a is performed by the MFP 2, it is possible to confirm the printed matter by performing the test printing the spot or confirm a printing image by the preview function easily. Moreover, since the user is able to input the initial setting value while viewing the printing result on the MFP 2, it is possible to perform a detailed setting such as the density, a color tone, a margin, a binder margin or the like easily.

Note that, although in the example of FIG. 5 described above, description has been given for the initial setting value input screen of the printer driver 14a, in the case of the scanner driver or the FAX driver as well, the setting value read from the setting value table is set/displayed on the initial setting value input screen and an initial setting value after adjusted appropriately by a user can be stored in the MFP 2.

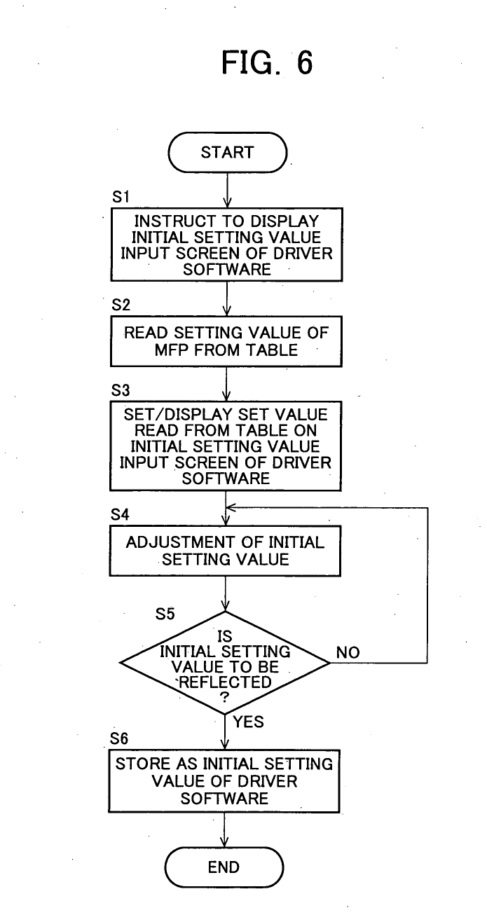

FIG. 6 is a flow diagram explaining an example of a method of inputting the initial setting value by the MFP 2 of the present invention. The user such as the administrator operates the operation portion 28 of the MFP 2 to instruct to display the initial setting value input screen 30 (FIG. 5) of the driver software 14a installed in the administrator PC 1 (step S1). On receipt of this display instruction, the MFP 2 reads out a setting value of the MFP 2 from the setting value table of the above-described FIG. 3 or FIG. 4 (step S2), sets/displays the read setting value on the initial setting value input screen 30 (step S3).

Next, the user performs adjustment to a desired initial setting value on the initial setting value input screen 30 displayed on the touch panel portion 28b of the operation portion 28 (step S4), and the MFP 2 determines whether or not the initial setting value is to be reflected (step S5). That is, when the OK button 34 on the initial setting value input screen 30 is depressed (in the case of YES), the initial setting value input to the initial setting value input screen 30 is stored in the HDD 25 as the initial setting value of the driver software 14a (step S6). Furthermore, at a step S5, when the OK button 34 of the initial setting value input screen 30 is not depressed (in the case of NO), the flow returns to the step S4 and the processing is repeated, however, when the cancel button 35 is depressed, or alternatively, when detecting that the OK button 34 is not depressed for a predetermined time, displaying of the initial setting value input screen 30 may be finished to stop the initial setting value input processing.

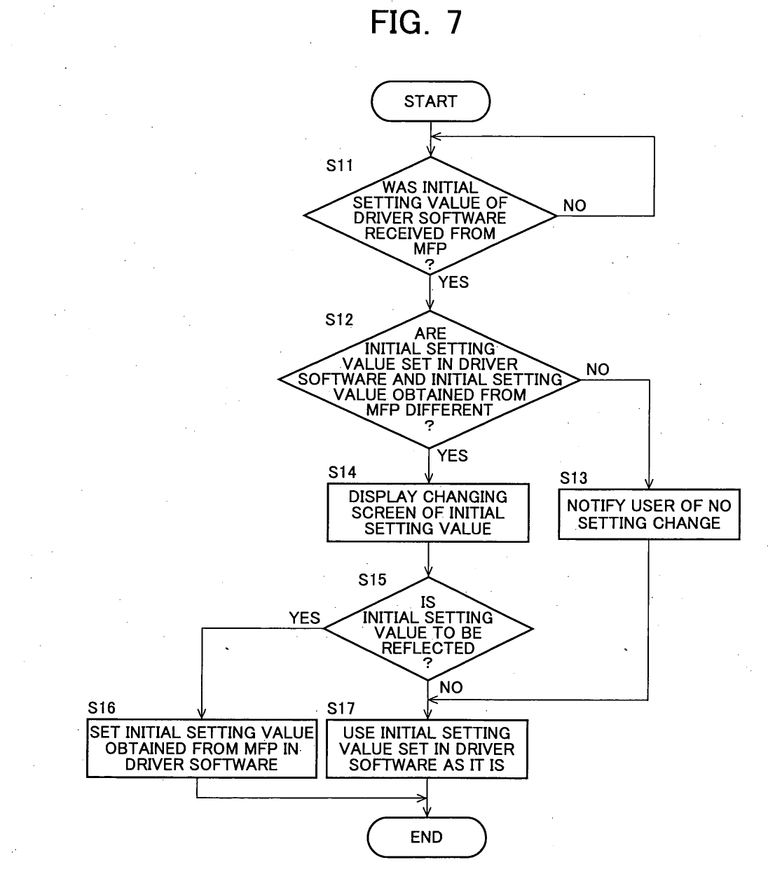

FIG. 7 is a flow diagram explaining an example of renewal processing of the initial setting value on the administrator PC 1. In this example, description will be given for a case where the initial setting value of the driver software 14a input and set at the MFP 2 is transmitted to the administrator PC 1. First, the administrator PC 1 determines whether or not the initial setting value of the driver software 14a is received from the MFP 2 (step S11), and when determines that the initial setting value is received from the MFP 2 (in the case of YES), determines whether or not the initial setting value set in the driver software 14a and the initial setting value obtained by the MFP 2 are different (step S12). Furthermore, at the above-described step S11, when determines that the initial setting value is not received from the MFP 2 (in the case of NO), the flow shift to a reception standby state at the step S11.

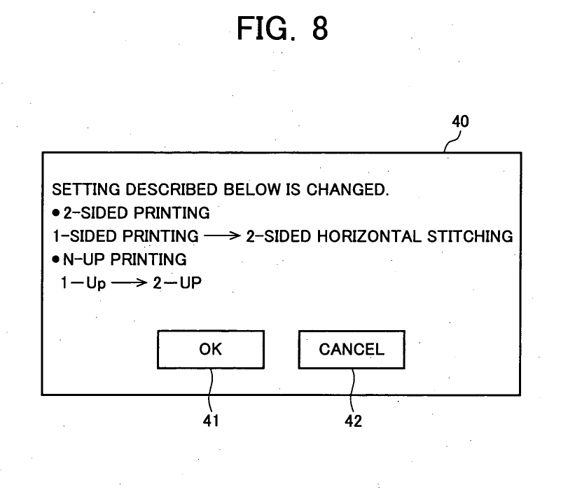

Next, when the administrator PC 1 determines, at the step S12, that the initial setting value of the driver software 14a and the initial setting value of the MFP 2 are the same (in the case of NO), informs the user of no setting change (step S13), and the flow shifts to a step S17. Furthermore, at the step S12, when the initial setting value of the driver software 14a and the initial setting value of the MFP 2 are determined to be different (in the case of YES), an initial setting value changing screen 40 as shown in FIG. 8 is displayed (step S14), and the administrator PC 1 determines whether or not the initial setting value is to be reflected (step S15). That is, when the OK button 41 on the initial setting value changing screen 40 is depressed (in the case of YES), the initial setting value changed on the initial setting value changing screen 40 is set to the driver software 14a (step S16). Moreover, at the step S15, when the cancel button 42 on the initial setting value changing screen 40 is depressed, or alternatively, when detecting that the OK button 41 is not depressed for a predetermined time, the initial setting value is not allowed to be changed and the initial setting value set in the driver software 14a is used as it is (step S17).

According to the present invention, since input of the initial setting value of the driver software such as the printer driver can be performed from the image forming apparatus, it is possible to input the initial setting value easily and prevent the erroneous input.

1. An image forming apparatus that is connectable through a network to an information processing apparatus in which driver software is installed, and is controlled by the driver software, wherein
an initial setting value input portion for inputting an initial setting value of the driver software is included and the initial setting value input by the initial setting value input portion is transmitted in response to a request from an external apparatus.

2. The image forming apparatus as defined in claim 1, wherein
a setting value table that stores a setting value of an image forming function included in the image forming apparatus is provided, the initial setting value input portion sets the setting value stored in the setting value table on an initial setting value input screen of the driver software as an initial setting value of the driver software so that a user can change the initial setting value set on the initial setting value input screen.

3. The image forming apparatus as defined in claim 2, wherein
the image forming apparatus includes any one or more of a printer function, a scanner function, and a facsimile function as the image forming function.

4. The image forming apparatus as defined in claim 2, wherein
it is possible to display a preview image based on an initial setting value before or after changed by a user on the initial setting value input screen.

5. The image forming apparatus as defined in claim 2, wherein
it is possible to execute a test printing based on an initial setting value before or after changed by a user on the initial setting value input screen.

6. The image forming apparatus as defined in any one of claims 2 to 5, wherein
when the image forming apparatus is provided with a plurality of image forming functions including a printer function, the setting value table includes a sharing setting value table that shares and stores at least a part of a setting value of the printer function and at least a part of a setting value of other image forming function except the printer function.

7. The image forming apparatus as defined in any one of claims 2 to 5, wherein
when the image forming apparatus is provided with a plurality of image forming functions including a printer function, the setting value table includes a first setting value table that stores a setting value of the printer function and a second setting value table that stores a setting value of other image forming function except the printer function.

8. The image forming apparatus as defined in claim 6, wherein
the other image forming function is a copy function.

9. The image forming apparatus as defined in any one of claims 1 to 5, wherein
a storage portion that stores an initial setting value of the driver software input by the initial setting value input portion is included.

10. An image forming system that an information processing apparatus in which driver software is installed and an image forming apparatus controlled by the driver software are connected through a network, wherein
the image forming apparatus includes an initial setting value input portion for inputting an initial setting value of the driver software and transmits the initial setting value input by the initial setting value input portion in response to a request from an external apparatus.
